(19) United States
(12) Patent Application Publication
(10) Pub. No.: US 2002/0064272 A1
(43) Pub. Date: May 30, 2002

(54) Call-waiting apparatus and method

(76) Inventors: David Naghi, Los Angeles, CA (US); Gilbert Fregoso, Santa Ana, CA (US)

Correspondence Address: STEPHEN C BEUERLE, PROCOPIO CORY HARGREAVES & SAVITCH, 530 B STREET, SUITE 2100, SAN DIEGO, CA, 92101, US

(21) Appl. No.: 09/727,734

(22) Filed: Nov. 30, 2000

(51) Int. Cl. H04M 3/42

(52) U.S. Cl. 379/215.01

(57) ABSTRACT

The present invention involves a call-waiting apparatus. The apparatus includes a line connector for connection to an incoming telephone line, a phone connector for connection to a telephone handset, and a modem/fax connector for connection to a computer modem or fax machine. The apparatus also includes a controller coupled to the line connector, phone connector, and the modem connector. The controller includes an automatic mode in which upon detecting a call-waiting signal from an incoming communication the controller automatically causes a connection between the line connector and the modem/fax connector to be changed to a connection between the line connector and the phone connector. The controller may also include a manual mode in which upon detecting a call-waiting signal from an incoming communication, the controller actuates one or more alarms indicating an incoming communication. The manual mode allows a user to take the communication, causing a connection between the line connector and the modem/fax connector to be changed to a connection between the line connector and the phone connector, or not take the communication wherein the connection between the line connector and the modem/fax connector is maintained.

### FIELD OF THE INVENTION

The present invention is in the field of telephonic switching devices for computing and electronic devices.

### BACKGROUND OF THE INVENTION

Recent estimates show that over 300,000,000 people use the Internet, and that number grows at a rate of 6,000,000 per month. Many of these users do not have an expensive high-speed Internet connection such as a T1, ISDN, DSL, or cable connection. Instead, most users connect to the Internet or other online services (e.g., gaming networks, dial-up networks, virtual private networks, etc.) via a modem on a home computer through a single telephone line that is the same as the line that is used for the telephone. While the user is on the Internet, this single phone line is tied up, generally resulting in a busy signal to anyone attempting to contact the user on the occupied telephone line. The same problem occurs with the use of fax machines.

In many areas, telephone companies offer a call-waiting feature where a signal (usually a beep) alerts a user on an active call that another call is attempting to connect on the occupied telephone line. The user may then opt for maintaining the current connection or switch over to the incoming call. Call waiting, however, is not useful when a computer modem or fax machine ties up the line because the modem or fax machine does not alert the user that another communication (e.g., telephone call, facsimile transmission) is attempting to connect on the occupied line. For example, a user may be connected to the Internet via the modem and facsimile transmission or telephone call may be coming in via the line that is being occupied by the modem. Not only is the user not alerted of the incoming communication, but the call-waiting signal often interrupts the connection, resulting in a faulty or severed connection, e.g., user is disconnected from the Internet, facsimile transmission is interrupted. For this reason, telephone companies also offer the option of temporarily turning off the call-waiting feature on a call-by-call basis. A user may program the modem or fax machine to temporarily shut off the call-waiting feature, maintaining a connection without a call-waiting interruption. Call-waiting users with inexpensive Internet connections, therefore, face the following dilemma in an attempt to solve this problem: either pay for two telephone lines, wherein one line is dedicated to the modem/fax machine and the other line is dedicated to voice transmission, or use the modem/fax machine with the call-waiting feature disabled and block all incoming communications. Obviously, the latter is disadvantageous if someone wants to be immediately alerted of an incoming communication.

Sprint® offers an expensive solution to the dilemma called Internet Call Waiting™. The name is a misnomer, however, because the system cannot work with the call-waiting feature active on the telephone line. The Sprint® system requires an additional feature on the telephone line named Call Forward Busy Line (“CFBL”) and also requires at least a Pentium 90 with 16 MB of RAM computer with a minimum 28.8 kbps modem connection. The user assigns Sprint® as the call forwarding number. When a user is on-line occupying the telephone line and a call comes in, the CFBL feature forwards the call to Sprint®, the Sprint® system then causes a pop-up window to flash on the user's computer screen to alert the user of the call. The user then has the following options: (1) listen as the caller leaves a message; (2) have the call forwarded to another telephone line; or (3) answer the call. Drawbacks to the Sprint® system include that it requires a monthly service charge paid to Sprint® and a CFBL charge from the local telephone company. Also, users that connect to the Internet behind a protective firewall cannot use the system. Moreover, the Sprint® system is limited to the Internet and does not work with other electronic telephone devices such as fax machines. The Sprint® system may not be available to all users because not all local telephone companies offer the CFBL option. Finally, the Sprint® system does not allow for automatic disconnection from the Internet when an incoming call comes in.

Another system that alerts a user on the Internet of an incoming telephone call is called the “Hot Call® HC2000”. A modem, telephone, and a single telephone line are plugged into the HC2000. When the user is on the Internet and a call-waiting signal occurs as a result of an incoming call, the HC2000 alerts the user visually and with an audio tone. The user may pick up the telephone plugged into the HC2000, causing the modem to become disconnected from the Internet, or ignore the call and stay on the Internet.

A major drawback of this system is that it does not allow for automatic disconnection from the Internet when an incoming call comes in. This is important for parents with kids that use the Internet constantly, especially if the parents are anticipating an important telephone call or other communication. Also, the HC2000 does not allow other telephones on the line to ring with the incoming call, so if, for example, a child is on the Internet, and a parent is in another room and does not hear the audio tone of the HC2000, the parent might not know of the incoming call.

The HC2000 is controlled with an expensive programmed microprocessor and includes a tone decoder for detecting an incoming call-waiting signal. Problems with the programmed microprocessor include that it draws significant power, it adds significant cost to this system and it is sensitive to Electro-static discharge (“ESD”). ESD protection adds further to the cost of this system (currently sells for $79.95). The high cost of the system is a problem because if consumers could afford such an expensive system, they could probably afford the cost of an additional telephone line, eliminating the need for the system in the first place. The high power-consumption requirements of the HC2000 are met through an AC adapter. However, in circumstances where an AC adapter can not be used (e.g., no outlet or additional outlet), the HC2000 can not be used because the system is not battery-compatible due to the high power-consumption requirements. The tone decoder in the system is a NE567 tone decoder, not a CMOS type, making the tone decoder less accurate at detecting a call-waiting signal, and more susceptible to noise, which can cause a false alert.

### SUMMARY OF THE INVENTION

Accordingly, an aspect of the present invention involves a call-waiting apparatus. The apparatus includes a line connector for connection to an incoming telephone line, a phone connector for connection to a telephone handset, and a modem/fax connector for connection to a computer modem or fax machine. The apparatus also includes a controller coupled to the line connector, phone connector, and the modem/fax connector. The controller includes an automatic mode in which upon detecting a call-waiting signal from an incoming communication the controller automatically causes a connection between the line connector and the modem/fax connector to be changed to a connection between the line connector and the phone connector.

Another aspect of the present invention involves a call-waiting apparatus, where the apparatus includes a line connector for connection to an incoming telephone line, a phone connector for connection to a telephone handset, and a modem/fax connector for connection to a computer modem or fax machine. The apparatus further includes a controller coupled to the line connector, phone connector, and the modem/fax connector. The controller includes one or more low power-consumption, integrated circuits, and a mode in which upon detecting a call-waiting signal from an incoming communication, the controller actuates one or more alarms (visual and/or audio) indicating an incoming communication, the mode allowing a user to take the communication, causing a connection between the line connector and the modem/fax connector to be changed to a connection between the line connector and the phone connector, or not take the communication wherein the connection between the line connector and the modem/fax connector is maintained.

A still further aspect of the present invention involves a method of alerting a connected user of an incoming communication on the same telephone line. The method includes providing a call-waiting apparatus including a line connector for connection to an incoming telephone line, a phone connector for connection to a telephone handset, and a modem/fax connector for connection to a computer modem or fax machine, and a controller coupled to the line connector, phone connector, and the modem/fax connector, the controller controlling connection between either the line connector and phone connector or the line connector and modem/fax connector; detecting a call-waiting signal from an incoming communication; and automatically causing a connection between the line connector and the modem/fax connector to be changed to a connection between the line connector and the phone connector.

These and other further objects and advantages will be apparent to those skilled in the art in connection with the drawings and the detailed description of the preferred embodiments set forth below.

### BRIEF DESCRIPTION OF THE DRAWINGS

The drawings illustrate the design and utility of preferred embodiments of the present invention, in which similar elements are referred to with common reference numerals:

FIG. 1 is a schematic illustration of an embodiment of a call-waiting apparatus for an electronic or computing device;

FIG. 2 is a schematic illustration of an embodiment of the components of the apparatus illustrated in FIG. 1.

FIG. 3 is a schematic illustration of an alternative embodiment of the components of the apparatus illustrated in FIG. 1.

FIG. 4 is a flowchart of an exemplary call-waiting method used by the apparatus illustrated in FIG. 1.

### DETAILED DESCRIPTION OF THE PREFERRED EMBODIMENT

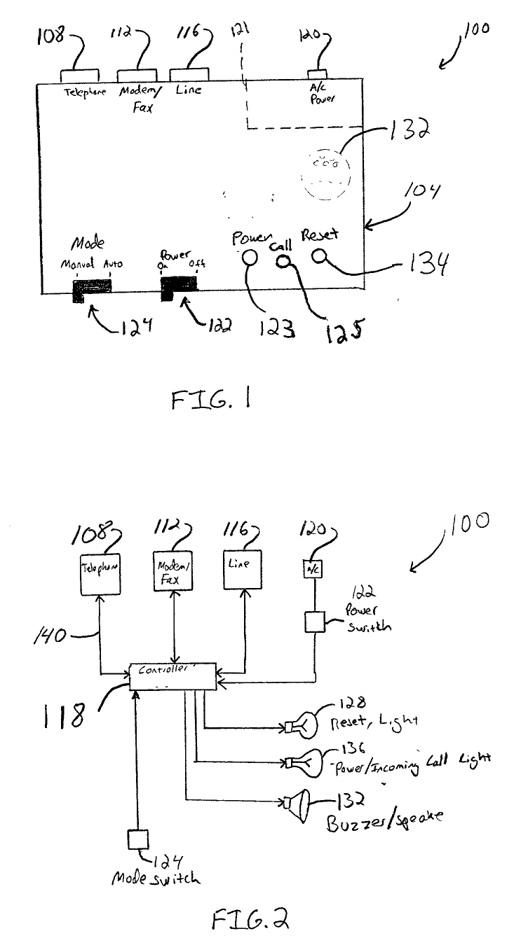

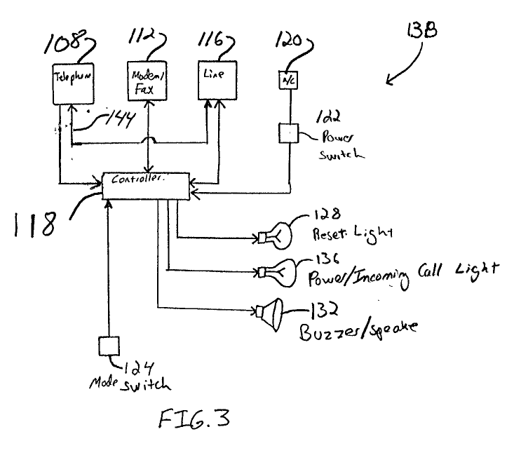

With reference to FIGS. 1 and 2, an embodiment of a call-waiting apparatus 100 and method for use with a communication device such as, but not limited to, a modem or a fax machine will now be described. The apparatus 100 may include a case or housing 104 that houses components of the apparatus that will be discussed in more detail below. The case 104 preferably carries three connectors: a telephone jack 108 adapted to be connected to a telephone handset, a modem or fax (“modem/fax”) jack 112 adapted to be connected to a modem or fax machine, and a line jack 116 adapted to be connected to an incoming telephone line such as through a wall jack. Each of the connectors 108, 112, 116 are connected to a controller 118 (FIGS. 2 and 3).

Although the apparatus 100 is generally described below as an add-on accessory having a case 104 and three jacks 108, 112, 116, in alternative embodiments, the apparatus 100 may not be housed in its own case 104 and may include connectors other than jacks and/or different numbers of jacks. For example, in an alternative embodiment of the apparatus 100, the apparatus 100 may include a line connector 116 and a telephone connector 108. In another embodiment, the apparatus 100 may include a line connector 116 and a modem/fax connector 112. Thus, the apparatus 100 may include a line connector 116 with either or both a telephone connector 108 and a modem/fax connector 112. Also, the apparatus 100 may be part of a circuit board (e.g., add-on computer card, motherboard designed to be part of main product such as a modem, computer or fax machine) and the connectors 108, 112, 116 may be contacts, ports, or elements in addition to or other than jacks. Further, if any jacks exist, there may be a different number of jacks than the three jacks 108, 112, 116 described below. For example, if the apparatus 100 was embodied in a computer card, there may be two jacks (e.g., a telephone jack 108 and a line jack 116) and the modem connector may be adapted to be coupled to an internal computer modem. Still further, the apparatus 100 may be part of a wall jack so that the line connector is connected to the incoming telephone line and the wall jack includes a telephone jack 108 and a modem/fax jack 112.

The controller 118 preferably includes one or more low power-consumption, CMOS-type integrated circuits. As used herein, low-power consumption for an integrated circuit means that the circuit draws 15 ma or less. In a preferred embodiment, the controller 118 includes the following CMOS-type connected integrated circuits: 1) a (TS555CD STMicroelectronics) timing integrated circuit, 2) a (TS556CD STMicroelectronics) timing integrated circuit, and 3) a LMC567C tone decoder, all sold by National Semiconductor Corporation of Santa Clara, Calif. These integrated circuits are used because, in contrast to the programmed microprocessor of the HC2000 system, they are inexpensive, reliable, do not require programming, are not ESD sensitive, draw extremely little power, and are readily available. The controller 118 is adapted to complete a connection between either the modem/fax jack 112 and the line jack 116, or the telephone jack 108 and the line jack 116. The LMC567C tone decoder is preferably set to detect a center frequency of 440 Hz+/−50 Hz and approximate response time of 10 ms. This causes the LMC567C to detect a call-waiting signal, usually a 440 Hz tone, causing the controller 118 to either 1) switch the connection between the line jack 116 and the modem/fax jack 112 to a connection between the line jack 116 and the telephone jack 108 (FIG. 2), or 2) sever the telephonic connection to the modem/fax jack 112 (FIG. 3). The LMC567C tone decoder consumes less power and is more accurate at detecting a call-waiting signal than the NE567 tone decoder used in the HC2000 system.

The apparatus 100 preferably draws 15 ma or less. An alternating current (“A/C”) jack 120 may receive a plug from an AC adapter or transformer to provide the DC power to the apparatus 100. Alternatively (or additionally), the apparatus 100 may include a battery compartment 121 that receives one or more batteries (either rechargeable or disposable) to power the apparatus 100. In a further embodiment, the apparatus 100 may draw power only from the telephone line since the telephone signal carries power. For example, the apparatus 100 may include a switching circuit and eliminate all the relays, which are electromechanical devices that consume considerable amounts of power. Because of the lower power-consumption requirements of the controller 118, the apparatus 100 may be powered by batteries (or only the telephone line) instead of an AC adapter. The HC2000 system draws significantly more power than the call-waiting apparatus 100, requiring an AC adapter for supplying power. The battery power supply capability of the apparatus 100 (or only power from the telephone line) allows the apparatus 100 to be used in circumstances where the HC2000 can not be used (e.g., where there is no outlet or no additional outlet).

The apparatus 100 further includes a power switch 122 that controls power from the A/C jack 120 (or other power source) by completing or interrupting a power supply circuit. When the power switch 122 is turned on and the apparatus 100 receives power, a power light 123 may be lit. The power light 123 may be any type of suitable lighting source including, but not limited to, one or more LEDs, incandescent light bulbs, or fluorescent light bulbs. A LED is preferable because of its low power-consumption requirements.

The apparatus 100 may also include a mode switch 124 coupled to the controller 118 that permits the user to select a manual mode or an automatic mode for the apparatus 100. In a manual mode, when the controller 118 detects the call-waiting signal of an incoming communication, the controller 118 may notify the user immediately of an incoming call by actuating one or more alarms such as sounding a buzzer/speaker 132 and/or illuminating an incoming call light 125. The manual mode gives the user the following three options. First, the user may answer the communication by picking up the connected telephone headset, severing the telephonic connection with the modem/fax machine. Instead of a headset, a fax machine may be connected to the telephone jack 108, and activating the fax machine would sever the connection made between the line jack 116 and modem/fax machine jack 112. Second, the user may disconnect from the Internet or finish a fax transmission manually and then answer the communication. Third, the user may ignore the incoming communication and stay connected. The manual mode is preferably selected when the user does not want to be automatically disconnected from the Internet or have a facsimile transmission automatically interrupted (e.g., sending or receiving an important fax, completing an online purchase, etc.).

In an automatic mode, when a call comes in, the apparatus 100 may sound the buzzer/speaker 132 and/or illuminate the incoming call light 125. The connection between the modem/fax jack 112 and line jack 116 is automatically interrupted when the call-waiting signal of an incoming communication is detected and an automatic connection is made between the line jack 116 and phone jack 108, allowing the user to answer the telephone headset or receive the fax as normal. Alternatively, the apparatus 100 in the automatic mode may not sound the buzzer/speaker 132 and/or illuminate the incoming call light 125. Instead, while in the automatic mode, the apparatus 100 may automatically terminate the modem/fax connection, allowing a connection to the telephone jack 108, which would allow the telephone connected to the telephone jack 108 (and other telephones on the same) to ring as normal to indicate an incoming communication. The automatic mode is preferably selected when the user is not concerned about a data transmission being automatically interrupted with an incoming telephone call or a facsimile transmission.

A major advantage of the call-waiting apparatus 100 over the HC2000 system is that the HC2000 does not allow for automatic disconnection from the Internet when an incoming call comes in. This is important for parents with kids that use various online connections or services such as online gaming, e-mail, Internet browsing, etc., especially if the parents are anticipating an important telephone call or fax. Also, the HC2000 does not allow other telephones on the line to ring with the incoming call, so if, for example, a child is on the Internet, and a parent is in another room and does not hear the audio tone of the HC2000, the parent might not know of the incoming call.

The apparatus 100 preferably resets itself (i.e., allows a connection between the line jack 116 and modem/fax jack 112) after a predetermined time period so that the modem/fax can be reconnected to the incoming line. Keeping the line jack 116 and modem/fax jack 112 disconnected for a predetermined period of time (e.g., wait a short period of time before re-connecting to the Internet) is important because many modems and faxes will attempt to re-establish a severed connection within a certain period of time after a disconnection. To accomplish this, the apparatus 100 severs the connection between the line jack 116 and modem/fax jack 112 for a predetermined time period greater than the maximum time period the modem/fax will take to attempt to reestablish a severed connection. The predetermined time period is preferably greater than 20 seconds. In a preferred embodiment, the predetermined time period is 30 seconds. In many cases, the user will engage the telephone headset longer than the predetermined time period, therefore, the apparatus 100 will not need to wait an additional time to reset once the user if off the telephone handset.

While the apparatus 100 is resetting, the apparatus 100 may illuminate a reset light 134, indicating that the internal controller 118 is not in a state that will complete the connection between the line jack 116 and the modem/fax jack 112. Once the apparatus 100 has reset, the reset light 134 will turn off, indicating that the internal controller 118 is ready to complete the connection from the line jack 116 to the modem/fax jack 112. At this point, a user may then reconnect a computer modem or fax machine to the telephone line and begin another data transmission. The reset light 128 is preferably a LED because of its low power-consumption requirements. However, other types of lighting sources may be used, such as, but not limited to, an incandescent light bulb or a fluorescent light bulb.

With reference to FIG. 3, an alternative embodiment of a call-waiting apparatus 138 will now be described. The call-waiting apparatus 138 is similar to the call-waiting apparatus 100 discussed with respect to FIG. 2, except that the telephone jack 108 is not coupled to the line jack 116 through the controller 118, but rather is connected directly to the line jack 116 through a connection 144. Accordingly, the telephone headset connected to the telephone jack 108 always has a connection with the line jack 116, regardless of the state of the controller 118.

The controller 118 completes a connection between the line jack 116 and the modem/fax jack 112 when the modem/fax is in use by detecting when the modem/fax is activating the line. When a call-waiting signal is detected and the user engages the telephone headset, the controller 118 severs the connection between the modem/fax jack 112 and the line jack 116, causing the line jack 116 and telephone jack 108 to be connected. Thus, in this embodiment, the controller 118 either completes the connection to the modem/fax jack 112 or severs that connection, while the apparatus 100 always maintains a connection between the line jack 116 and the telephone jack 108.

When the modem/fax is activating the line and another communication is not coming in, the controller 118 will not sever the connection between the modem/fax jack and the line jack 116, even if the telephone headset is activated by the user. The preference for maintaining the modem/fax jack 112 connection, however, is overridden when a call-waiting signal is received by the controller 118.

For example, if the mode switch 124 is set to the manual mode and a call-waiting signal is detected by the controller 118, the user may pick up the telephone headset, activating the line, and the controller 118 will sever the connection between the modem/fax jack 112 and the line jack 116. If the user does not pick up the headset or otherwise engage the telephone line, the modem/fax connection remains unaltered.

In the automatic mode, the controller 118 will detect a call-waiting signal and will automatically sever the connection between the modem/fax jack 112 and the line jack 116 regardless of the user's actions.

In either the manual or automatic mode, the controller 118 may illuminate the incoming call light 125 and/or sound the buzzer/speaker 132 upon receiving the call-waiting signal. Instead of, or in addition to, the buzzer 132 and light 123 indication, a telephone connected to the telephone jack 108 rings as normal to indicate an incoming communication to the user.

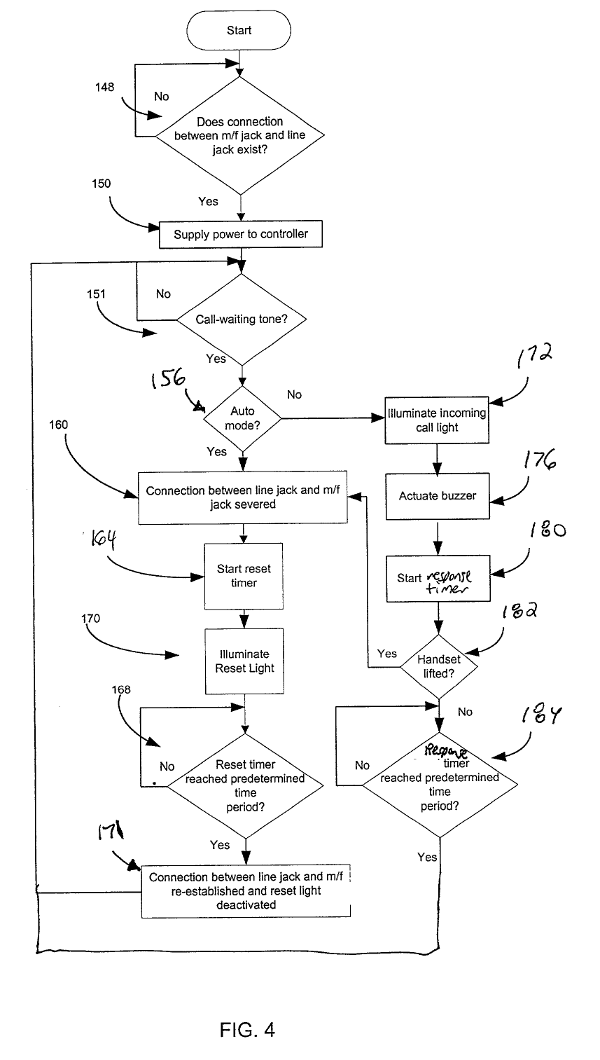

FIG. 4 is a flow chart of the logic employed by the controller 118 for the embodiment of the call-waiting apparatus illustrated in FIG. 3. At step 148, the controller 118 determines whether a connection from the modem/fax jack (“m/f jack”) 112 and the line jack 116 exists. Such a connection would exist if, for example, a computer were logged on to the Internet via a modem. If no connection exists, then the logic procedure begins again with step 148.

Once a connection is detected at step 148, at step 150, the controller 118 will supply power from the A/C jack 120 or other power source to the rest of the controller switch circuit including the call-waiting tone detector.

At step 151, the existence of a call-waiting tone is determined. If the controller 118 does not detect a call-waiting tone, the logic procedure loops back to step 151. On the other hand, if the controller 118 detects a call-waiting tone (usually a 440 Hz tone), then the logic procedure continues to step 156.

At step 156, the controller 118 determines whether the apparatus 138 is in automatic mode (“auto mode”). If the mode switch 124 is set to automatic mode, control passes to step 160. At step 160, the telephonic connection between the line jack 116 and the modem/fax 112 is severed. Simultaneously, at step 164, the controller 118 begins a reset timer during which the controller 118 prevents the modem/fax from reestablishing a connection as described above. At step 168, while the reset timer is running, the controller 118 illuminates the reset light 134. At step 170, a determination is made as to whether the reset time has reached a predetermined time limit (e.g., 30 seconds). Once the predetermined reset limit is reached, a connection between the modem/fax jack 112 and the line jack 116 (step 171) is reestablished and the procedure then loops back up to step 151.

If the mode switch 124 is set to manual, control passes from step 156 to step 172. At step 172, the controller 118 illuminates the incoming call light 125. At step 176, the buzzer/speaker 132 may be sounded. At step 180, a call-waiting response timer, which allows the user a preset amount of time (e.g., 20 seconds) to lift the handset and answer the incoming call, may be initiated. The logic procedure continues by monitoring in step 184 whether the user lifts the telephone headset. Once the user lifts the headset, the controller continues to step 160. If, however, the user does not lift the headset before the call-waiting response timer expires, then the logic procedure continues to step 184. At step 184, it is determined whether the response timer has reached predetermined limit. If not, control loops back to 184. If so, control passes to step 151.

The present invention solves the problems of the past with an inexpensive call-waiting apparatus that alerts a user connected to the Internet or other online service, to the telephone, or to another fax machine of an incoming communication and gives the user the option of 1) automatic disconnection mode (automatic disconnection from the existing connection such as the Internet upon incoming communications), or 2) manual disconnection mode (the user may take the incoming communication and disconnect from the existing connection (e.g., Internet), or not and stay connected). Providing an automatic disconnection mode, as described above, is especially advantageous for parents with kids that use a shared phone line constantly, especially if the parents are anticipating an important telephone call or facsimile transmission. An automatic disconnection mode also allows all telephones connected to a main line to ring with the incoming call when a user is connected.

Another major advantage of the present invention is its low power-consumption requirements. This allows the apparatus to be powered by one or more batteries or by the incoming telephone line so that the apparatus can be used where additional outlets or no outlets are available for supplying AC power.

The apparatus also does not require an outside service to monitor and route calls, consequently, the apparatus avoids monthly service charges. The apparatus also may be used with computer modems and other electronic telecommunication devices such as, but not limited to, fax machines, and may be used behind a protective firewall.

While embodiments and applications of this invention have been shown and described, it would be apparent to those in the field that many more modifications are possible without departing from the inventive concepts herein. The invention, therefore, is not to be restricted except in the spirit of the appended claims.

We claim:

1. A call-waiting apparatus, comprising:
a line connector for connection to an incoming telephone line, a phone connector for connection to a telephone handset, and a modem/fax connector for connection to a computer modem or fax machine;
a controller coupled to the line connector, phone connector, and the modem/fax connector, the controller including an automatic mode in which upon detecting a call-waiting signal from an incoming communication the controller automatically causes a connection between the line connector and the modem/fax connector to be changed to a connection between the line connector and the phone connector.

2. The apparatus of claim 1, wherein the controller further includes a manual mode in which upon detecting a call-waiting signal from an incoming communication, the controller actuates one or more alarms indicating an incoming communication, the manual mode allowing a user to take the communication, causing a connection between the line connector and the modem/fax connector to be changed to a connection between the line connector and the phone connector, or not take the communication wherein the connection between the line connector and the modem/fax connector is maintained.

3. The apparatus of claim 2, wherein the housing includes a switch for switching between the manual mode and the automatic mode.

4. The apparatus of claim 1, wherein the controller includes a reset timer that prevents a re-connection of the connection between the line connector and the modem/fax connector for at least twenty seconds once the connection between the line connector and the modem/fax connector is changed to a connection between the line connector and the phone connector.

5. The apparatus of claim 1, wherein the controller includes one or more integrated circuits.

6. The apparatus of claim 4, wherein the one or more integrated circuits includes one or more low power-consumption, CMOS-type integrated circuits.

7. The apparatus of claim 1, wherein the connectors are jacks, and the apparatus further includes a case for housing said controller and jacks.

8. The apparatus of claim 1, wherein the controller and connectors are part of a circuit board.

9. The apparatus of claim 1, wherein the controller includes a tone decoder with a center frequency of 440 Hz+/−50 Hz, and a response time of approximately 10 ms.

10. The apparatus of claim 1, wherein the power-consumption of the apparatus is 15 ma or less.

11. The apparatus of claim 1, wherein the apparatus is powered by one or more batteries.

12. The apparatus of claim 1, wherein the apparatus is powered by power from the incoming telephone line.

13. The apparatus of claim 1, wherein the line connector and the modem/fax connector are always connected and the controller causes the connection between the line connector and the modem/fax connector to be superseded by a connection between the line connector and the phone connector upon detecting a call-waiting signal from an incoming communication.

14. A call-waiting apparatus, comprising:
a line connector for connection to an incoming telephone line, a phone connector for connection to a telephone handset, and a modem/fax connector for connection to a computer modem or fax machine;
a controller coupled to the line connector, phone connector, and the modem/fax connector, the controller including one or more low power-consumption, integrated circuits, the controller including a mode in which upon detecting a call-waiting signal from an incoming communication, the controller actuates one or more alarms indicating an incoming communication, the mode allowing a user to take the communication, causing a connection between the line connector and the modem/fax connector to be changed to a connection between the line connector and the phone connector, or not take the communication wherein the connection between the line connector and the modem/fax connector is maintained.

15. The apparatus of claim 14, wherein the controller includes a reset timer that prevents a re-connection of the connection between the line connector and the modem/fax connector for at least twenty seconds once the connection between the line connector and the modem/fax connector is changed to a connection between the line connector and the phone connector.

16. The apparatus of claim 14, wherein the connectors are jacks, and the apparatus further includes a case for housing said controller and jacks.

17. The apparatus of claim 14, wherein the controller and connectors are part of a circuit board.

18. The apparatus of claim 14, wherein the controller includes a tone decoder with a center frequency of 440 Hz+/−50 Hz, and a response time of approximately 10 ms.

19. The apparatus of claim 14, wherein the power-consumption of the apparatus is 15 ma less.

20. The apparatus of claim 14, wherein the apparatus is powered by one or more batteries.

21. The apparatus of claim 14, wherein the apparatus is powered by power from the incoming telephone line.

22. A method of alerting a user on a telephone line or others nearby of an incoming communication on the same telephone line, comprising:
providing a call-waiting apparatus including a line connector for connection to an incoming telephone line, a phone connector for connection to a telephone handset, and a modem/fax connector for connection to a computer modem or fax machine, and a controller coupled to the line connector, phone connector, and the modem/fax connector, the controller for controlling connection between either the line connector and phone connector or the line connector and modem/fax connector;
detecting a call-waiting signal from an incoming communication;
automatically causing a connection between the line connector and the modem/fax connector to be changed to a connection between the line connector and the phone connector.

23. The method of claim 22, wherein the call-waiting apparatus includes an automatic mode in which the above method automatically occurs upon detecting a call-waiting signal from an incoming communication and a connection exists between the line connector and the modem/fax connector.

24. The method of claim 22, wherein the call-waiting apparatus further includes a manual mode, the method further including selecting the manual mode, upon detecting a call-waiting signal from an incoming communication, actuating one or more alarms indicating an incoming communication, and further allowing a user to take the communication, causing a connection between the line connector and the modem/fax connector to be changed to a connection between the line connector and the phone connector, or not take the communication wherein the connection between the line connector and the modem/fax connector is maintained.

25. The method of claim 22, further including preventing a re-connection of the connection between the line connector and the modem/fax connector for at least twenty seconds once the connection between the line connector and the modem/fax connector is changed to a connection between the line connector and the phone connector.

26. The method of claim 22, wherein the controller includes one or more low power-consumption, CMOS-type integrated circuits.

27. The method of claim 22, wherein the connectors are jacks, and the apparatus further includes a case for housing said controller and jacks.

28. The method of claim 22, wherein the controller and connectors are part of a circuit board.

29. The method of claim 22, wherein the controller includes a tone decoder with a center frequency of 440 Hz+/−50 Hz, and a response time of approximately 10 ms.

30. The method of claim 22, wherein the power-consumption of the apparatus is 15 ma or less.

31. The method of claim 22, further including powering the apparatus with one or more batteries.

32. The method of claim 21, further including powering the apparatus by power from the incoming telephone line.
